(19) United States
(12) Patent Application Publication
(10) Pub. No.: US 2016/0062728 A1
(43) Pub. Date: Mar. 3, 2016

(54) DRAWING CONTROL APPARATUS, INFORMATION SHARING SYSTEM, DRAWING CONTROL METHOD, AND RECORDING MEDIUM STORING DRAWING CONTROL PROGRAM

(71) Applicant: NEC Corporation, Tokyo (JP)

(72) Inventor: Yuuya FURUOKA, Tokyo (JP)

(73) Assignee: NEC Corporation

(21) Appl. No.: 14/743,180

(22) Filed: Jun. 18, 2015

(30) Foreign Application Priority Data
Aug. 28, 2014 (JP) 2014-173348

(51) Int. Cl. G06F 3/14; G09G 5/34; G09G 5/377; G06F 3/041; G09G 5/373

(52) U.S. Cl. CPC G06F 3/1462; G06F 3/0416; G09G 5/373; G09G 5/377; G09G 5/34; G09G 2354/00; G09G 2370/22; G09G 2370/20; G09G 2340/14; G09G 2340/045; G09G 2340/0464; G09G 2340/12

(57) ABSTRACT

Disclosed is a drawing control apparatus capable of efficiently performing the adjustment process of avoiding overlap between the writing areas for the users who have gained access on-line writes.

The drawing control apparatus includes a determination unit, a change unit, and a move unit. The determination unit determines whether a first drawn image drawn in a first drawing area. The change unit changes a size and a position in the drawing screen regarding the first drawing area so that the first drawn image is contained in the first drawing area. The change unit changes a size and a position in the drawing screen regarding the second drawing area so that the second drawing area does not overlap with the first drawing area. The move unit moves a second drawn image, according to the size and the position regarding the second drawing area obtained after change regarding the second drawing area.

This application is based upon and claims the benefit of priority from Japanese Patent Application No. 2014-173348, filed on Aug. 28, 2014, the disclosure of which is incorporated herein in its entirety by reference.

### TECHNICAL FIELD

The present invention relates to an information sharing apparatus (information processing apparatus), such as a whiteboard or an electronic blackboard, that allows people to perform the writing and sharing of information, etc., in an online environment and, more particularly, to a technology that controls the drawing related to such information.

### BACKGROUND ART

In recent years, in order to realize intra-company or inter-company collaboration, information sharing apparatuses that support a plurality of users' sharing information are utilized in various instances. One of such information sharing apparatuses is an on-line accessible whiteboard (referred to “online WB” in the following description in this application) that allows users to freely write in information, such as ideas, and visualizes the written-in information for the users. The Users of this online WB can expand their ideas by writing characters, graphics, etc., in free layouts and sharing the written information with other users. Therefore, technologies related to the information sharing apparatuses, such as the above-described online WB, are drawing attention.

Japanese Registered Patent Publication No. 4321203 discloses an example of such technologies, a teleconference system that is capable of providing a shared work space for conference participants to easily have an inter-conference system connection or share information with other conference participants. This teleconference system includes apparatuses such as an electronic blackboard, and smoothly carries out operations related to information utilized at the conference, such as collection, management, analysis, display and distribution, on the basis of simple operations of users.

Japanese Registered Patent Publication No. 4280524 discloses a collaboration work system employing an electronic whiteboard application which makes it possible to simultaneously write into a whiteboard screen from a plurality of user terminal apparatuses that are shared via a network. This collaboration work system displays whiteboard screens suitable for the user terminal apparatuses by prescribing whiteboard screen display methods on the basis of the screen display capabilities of the user terminal apparatuses.

Re-publication of PCT International Publication No. WO2010140570 discloses a system capable of securing real-timeness when an electronic conference system is provided by a web application. This system has an application server and a comet server. The application server controls the comet server so that the comet server receives a request from a client terminal apparatus and assumes a suspended state. The application server obtains necessary data from a conference database when having received message data from a specific client terminal apparatus. After that, the comet server sends the necessary data and the message data to the client terminal apparatus concerned.

When a plurality of users shares information by using an online whiteboard (WB), writing areas in the online WB for the users are determined beforehand separately for each user in order to distinguish contents written by the users. Then, each user writes objects such as characters, shapes, etc. into the user's own writing area in the online WB. An example in which a plurality of users shares an online WB and writes information into the WB is illustrated in FIG. 18.

In the example illustrated in FIG. 18, four users A, B, C and D have written information into an online WB 500. The user A writes information into a writing area 501 for the user A. The user B writes information into a writing area 502 for the user B. The user C writes information into a writing area 503 for the user C. The user D writes information into a writing area 504 for the user D. These writing areas have been set so as not to overlap with each other.

Each user, during an early period, writes information into the user's writing area in the online WB 500. However, if, as a user's thinking and idea expands, blank portions become scarce in the user's writing area, the user may sometimes write information outside the user's writing area. FIG. 19 illustrates an example in which a content written by a certain user has overlapped with the writing area for another user when a plurality of users shares an online WB and writes information into the online WB.

In the example illustrated in FIG. 19, a string of characters “abcdefgh” written by the user A into the online WB 500 extends beyond the writing area 501 for the user A and penetrates the writing area 502 for the user B. In this case, in order to make the information written by the user A and the information written by the user B distinguishable from each other, it is necessary to move the writing area 502 for the user B so that the string of characters “abcdefgh” does not penetrate the writing area 502 for the user B. Incidentally, when the area for a certain user is to be moved, it is desirable to maintain relative positional relationship among the individual users' writing areas as much as possible so that the images written in the online WB 500 do not considerably change.

In the case illustrated in FIG. 19, it is necessary to move the writing area 502 for the user B rightward so that the string of characters “abcdefgh” does not penetrate the writing area 502 for the user B. However, when the writing area 502 for the user B is moved rightward, the writing area 502 for the user B, in turn, overlaps with the writing area 503 for the user C. Therefore, in this case, it is necessary to move the writing area 503 for the user C downward so as to secure a blank space to the right of the writing area 502 for the user B before moving the writing area 502 for the user B rightward.

In a typical system in which a plurality of users shares information by using an online WB, the foregoing adjustment process regarding movement of the writing areas for users is performed by each user according to need. Depending on the positional relationship concerning the writing areas for users in an online WB, it can happen that in conjunction with movement of the writing area for a certain user, an adjustment process of moving many other users' writing areas is frequently carried out. This gives rise to a problem of increased burdens on the users. The technologies disclosed by the foregoing three patent documents do not solve this problem.

A main object of the present invention is to provide a drawing control apparatus and the like in which this problem is solved.

### SUMMARY

A drawing control apparatus according to an exemplary aspect of the present invention includes: a determination unit configured to determine whether, in information that represents a drawing screen that includes a plurality of drawing areas, a first drawn image drawn based on an instruction that the first drawn image be drawn in a first drawing area of the plurality of drawing areas is contained in the first drawing area; a change unit configured to, when, in the information that represents the drawing screen, the first drawn image is not contained in the first drawing area, change at least either information that represents a size regarding the first drawing area or information that represents a position in the drawing screen regarding the first drawing area so that the first drawn image is contained in the first drawing area, and to change at least either information that represents a size regarding a second drawing area of the plurality of drawing areas or information that represents a position in the drawing screen regarding the second drawing area so that the second drawing area does not overlap with the first drawing area; and a move unit configured to move a second drawn image drawn based on an instruction that the second drawn image be drawn in the second drawing area, according to the size and the position regarding the second drawing area that are obtained after change regarding the second drawing area.

A drawing control method according to an exemplary aspect of the present invention includes: by an information processing apparatus, determining whether, in information that represents a drawing screen that includes a plurality of drawing areas, a first drawn image drawn based on an instruction that the first drawn image be drawn in a first drawing area of the plurality of drawing areas is contained in the first drawing area; when, in the information that represents the drawing screen, the first drawn image is not contained in the first drawing area, changing at least either information that represents a size regarding the first drawing area or information that represents a position in the drawing screen regarding the first drawing area so that the first drawn image is contained in the first drawing area, and changing at least either information that represents a size regarding a second drawing area of the plurality of drawing areas or information that represents a position in the drawing screen regarding the second drawing area so that the second drawing area does not overlap with the first drawing area; and moving a second drawn image drawn based on an instruction that the second drawn image be drawn in the second drawing area, according to the size and the position regarding the second drawing area that are obtained after change regarding the second drawing area.

A non-transitory computer-readable medium according to an exemplary aspect of the present invention stores a drawing control program casing a computer to realize: a determination function configured to determine whether, in information that represents a drawing screen that includes a plurality of drawing areas, a first drawn image drawn based on an instruction that the first drawn image be drawn in a first drawing area of the plurality of drawing areas is contained in the first drawing area; a change function configured to, when, in the information that represents the drawing screen, the first drawn image is not contained in the first drawing area, change at least either information that represents a size regarding the first drawing area or information that represents a position in the drawing screen regarding the first drawing area so that the first drawn image is contained in the first drawing area, and to change at least either information that represents a size regarding a second drawing area of the plurality of drawing areas or information that represents a position in the drawing screen regarding the second drawing area so that the second drawing area does not overlap with the first drawing area; and a move function configured to move a second drawn image drawn based on an instruction that the second drawn image be drawn in the second drawing area, according to the size and the position regarding the second drawing area that are obtained after change regarding the second drawing area.

### BRIEF DESCRIPTION OF THE DRAWINGS

Exemplary features and advantages of the present invention will become apparent from the following detailed description when taken with the accompanying drawings in which:

FIG. 1 is a block diagram illustrating a construction of an information sharing system according to a first exemplary embodiment of the present invention;

FIG. 2 is a diagram illustrating a construction example of an online WB according to the first exemplary embodiment of the present invention;

FIG. 3 is a diagram illustrating a construction example of a drawing area management information according to the first exemplary embodiment of the present invention;

FIG. 4 is a diagram illustrating a construction example of drawn image management information according to the first exemplary embodiment of the present invention;

FIG. 5 is a first example in which contents written in an online WB according to the first exemplary embodiment of the present invention has been changed;

FIG. 6 is a diagram illustrating a construction example of drawing area management information (after contents written in the online WB have been changed in the example illustrated in FIG. 5) according to the first exemplary embodiment of the present invention;

FIG. 7 is a diagram illustrating a construction example of drawn image management information (after contents written in the online WB have been changed in the example illustrated in FIG. 5) according to the first exemplary embodiment of the present invention;

FIG. 8 is a diagram illustrating a second example concerning update of contents written in an online WB according to the first exemplary embodiment of the present invention;

FIG. 9 is a diagram illustrating a third example concerning update of contents written in an online WB according to the first exemplary embodiment of the present invention;

FIG. 10 is a diagram illustrating a fourth example concerning update of contents written in an online WB according to the first exemplary embodiment of the present invention;

FIG. 11 is a diagram illustrating an example in which contents displayed on a display screen have been adjusted along with update of contents written in an online WB according to the first exemplary embodiment of the present invention;

FIG. 12 is a flowchart illustrating an operation of an information sharing system according to the first exemplary embodiment of the present invention;

FIG. 13 is a diagram illustrating a first modification of area setting concerning an online WB according to the first exemplary embodiment of the present invention;

FIG. 14 is a diagram illustrating a second modification of the area setting concerning an online WB according to the first exemplary embodiment of the present invention;

FIG. 15 is a diagram illustrating a third modification of the area setting concerning an online WB according to the first exemplary embodiment of the present invention;

FIG. 16 is a block diagram illustrating a construction of a drawing control apparatus according to a second exemplary embodiment of the present invention;

FIG. 17 is a block diagram illustrating a construction of an information processing apparatus capable of realizing drawing control apparatuses according to various exemplary embodiments of the present invention;

FIG. 18 is a diagram illustrating an example in which a plurality of users shares an online WB and writes information into the online WB; and

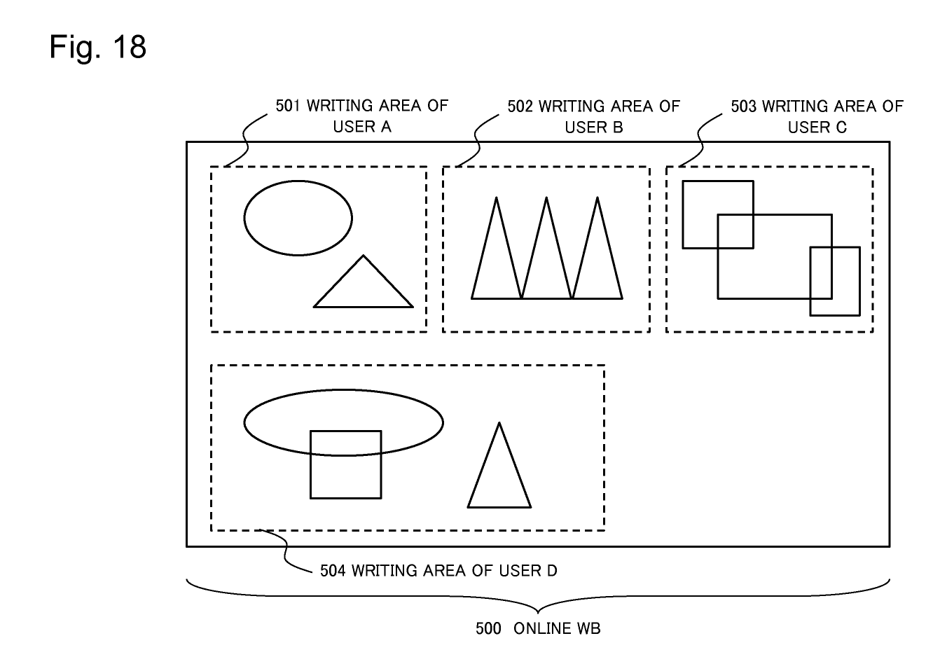

FIG. 19 is a diagram illustrating an example in which a content written by a certain user has overlapped with the writing area of another user when a plurality of users shares an online WB and writes information into the online WB.

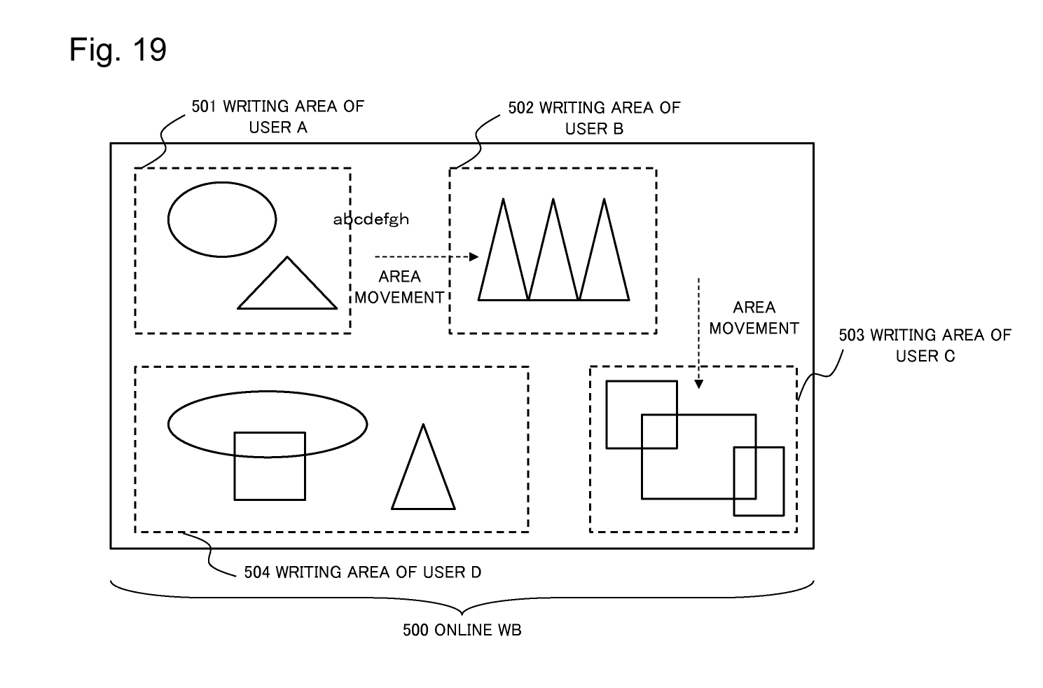

### EXEMPLARY EMBODIMENT

Exemplary embodiments of the present invention will be described in detail hereinafter with reference to the accompanying drawings.

### First Exemplary Embodiment

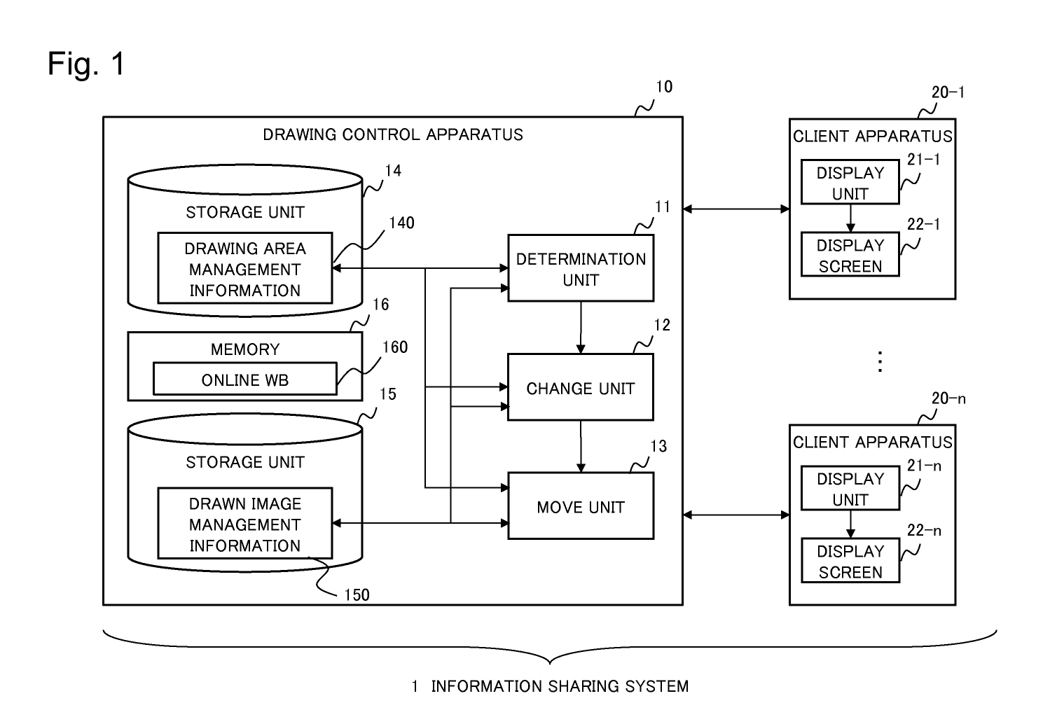

FIG. 1 is a block diagram conceptually illustrating a construction of an information sharing system 1 according to a first exemplary embodiment of the present invention. The information sharing system 1 according to the first exemplary embodiment is a system that assists a plurality of users in sharing information in an online environment. The information sharing system 1 provides an online whiteboard (WB) 160 made up of data about a drawing screen in which a plurality of users can visually share information.

The information sharing system 1 according to this exemplary embodiment includes a drawing control apparatus 10 and n (n is an integer of 2 or more) number of client apparatuses 20-1 to 20-n. The drawing control apparatus 10 and the client apparatuses 20-1 to 20-n are connected for communication with each other.

Each of the client apparatuses 20-1 to 20-n is an information processing apparatus, for example, a personal computer or the like, that a user uses to write drawing information into the online WB 160 or refer to the drawing information written in the online WB 160. The client apparatus 20-1 includes a display unit 21-1 and a display screen 22-1. The display unit 21-1 receives the drawing information written in the online WB 160 from the drawing control apparatus 10 and displays the drawing information as a drawn image on the display screen 22-1 (in the display screen 22-1). The client apparatuses 20-2 to 20-n have substantially the same construction and functions as the client apparatus 20-1. Each of the display units 21-1 to 21-n, following instructions from a user, displays the entire online WB 160 in some cases and displays a portion of the online WB 160 in some other cases. When a user writes information into the online WB, the corresponding client apparatus 20-1 to 20-n sends the information as drawing information to the drawing control apparatus 10.

The drawing control apparatus 10 includes a determination unit 11, a change unit 12, a move unit 13, a storage unit 14, a storage unit 15, and a memory 16. The determination unit 11, the change unit 12, and the move unit 13 are electronic circuits in some cases, and are realized by computer programs (software programs) and a processor that operates according to computer programs in some other cases. The storage unit 14 and the storage unit 15 are storage devices, such as electronic circuits or magnetic disks, the access to which is controlled by electronic circuits or by computer programs and a processor that operates according to computer programs.

The memory 16 stores the online WB 160. When the drawing control apparatus 10 receives drawing information that indicates the writing into the online WB 160 from at least any one of the client apparatuses 20-1 to 20-n, the drawing control apparatus 10 updates the contents drawn in the online WB 160, on the basis of the drawing information.

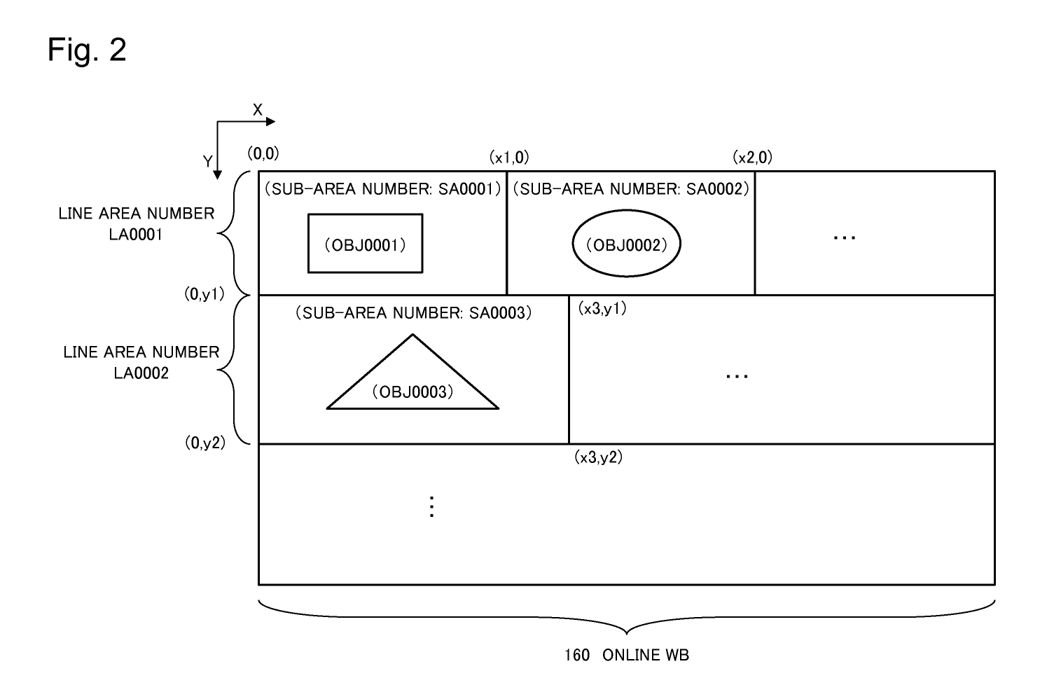

A construction example of the online WB 160 according to this exemplary embodiment is illustrated in FIG. 2. As exemplified in FIG. 2, the online WB 160 includes a plurality of line areas. These line areas are each given a line area number such as LA0001, LA0002, and so on. These line area numbers are given by the drawing control apparatus 10, a system administrator, or the like. Hereinafter in this patent application, a line area whose line area number is, for example, LA0001, will be referred to “line area LA0001”.

Each line area includes one or more sub-areas. These sub-areas are given sub-area numbers such as SA0001, SA0002, SA0003, and so on. These sub-area numbers are given by the drawing control apparatus 10, the system administrator, or the like. Hereinafter in this patent application, a sub-area whose sub-area number is, for example, SA0001, will be referred to “sub-area SA0001”. In the example illustrated in FIG. 2, the line area LA0001 includes sub-areas such as sub-areas SA0001 and SA0002. Likewise, the line area LA0002 includes sub-areas such as a sub-area SA0003.

As illustrated in FIG. 2, in the sub-area SA0001 there is drawn an object (drawn image) given an object number of OBJ0001. Such an object number is given by the move unit 13 when any one of the client apparatuses 20-1 to 20-n instructs that drawing into the online WB 160 be performed. Hereinafter in this patent application, an object whose object number is, for example, OBJ0001, will be referred to “object OBJ0001”. Likewise, in the sub-areas SA0002 and SA0003 there are drawn objects OBJ0002 and OBJ0003, respectively. As illustrated in FIG. 2, positions in the online WB 160 can be represented by a two-dimensional coordinate system (xy coordinate system) whose origin is an upper left point of the online WB 160.

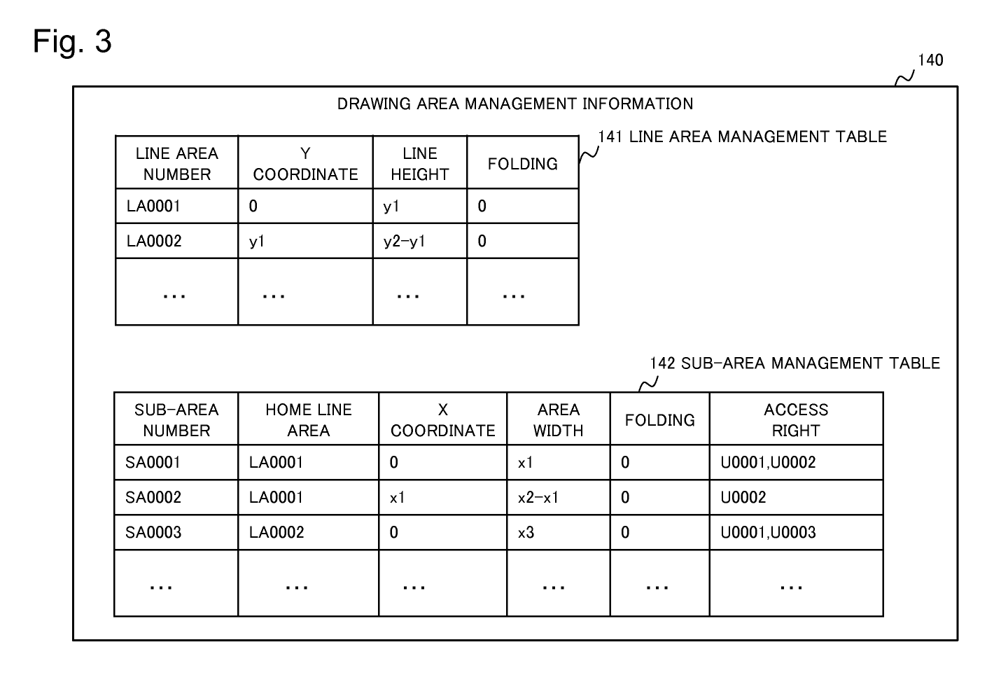

As illustrated in FIG. 1, the storage unit 14 stores drawing area management information 140. FIG. 3 illustrates a construction example of the drawing area management information 140 according to this exemplary embodiment. As exemplified in FIG. 3, the drawing area management information 140 includes a line area management table 141 and a sub-area management table 142.

The line area management table 141 is a table for managing the state of each line area. The line area management table 141 has records in which items of “line area number”, “y coordinate” “line height”, and “folding” are associated with each other.

The “line area number” indicates the line area number given to each line area. In the example illustrated in FIG. 3, LA0001, LA0002, and the like indicated in FIG. 2 are registered. The “y coordinate” is a value that indicates a position in the online WB 160, with regard to the line area indicated by the record. The “y coordinate” in the line area management table 141 indicates the y coordinate (y coordinate value) of an upper side (origin-side side) of the line area indicated by the concerned record. As exemplified in FIG. 2, the y coordinates of the line areas LA0001 and LA0002 are “0” and “y1”, respectively.

The “line height” in the line area management table 141 is a value that indicates the height of the line area indicated by the record in the y-coordinate direction. As exemplified in FIG. 2, the line heights of the line areas LA0001 and LA0002 are “y1” and “y2-y1”, respectively.

The “folding” in the line area management table 141 is information that indicates whether a line area indicated by the concerned record is in a folded-in state (folded state) in the online WB 160. In this exemplary embodiment, the folded state indicates a state in which an area has been reduced to a predetermined size while the information about an object drawn (developed) in the area is retained in the memory 16. In this exemplary embodiment, placing a cursor on the area reduced to the folded state by using a pointing device (not depicted), such as a mouse, allows the user to check the summary or the like of the information drawn in the area. In this exemplary embodiment, when the drawing control apparatus 10 receives from any one of the client apparatuses drawing information that instructs that a specific line area be in the folded state, the drawing control apparatus 10 reduces the size of that specific line area in the direction of the origin in terms of the y coordinate and thus updates the online WB 160. In the example illustrated in FIG. 3, the value indicated by the “folding” concerning the line areas LA0001 and LA0002 is “0”, indicating that neither one of the line areas LA0001 and LA0002 is in the folded state.

The sub-area management table 142 is a table for managing the state of each sub-area. The sub-area management table 142 includes records in which items of “sub-area number”, “home line area”, “x coordinate”, “area width”, “folding”, and “access right” are associated with each other.

The item “sub-area number” indicates the sub-area number given to each sub-area. In the example indicated in FIG. 3, sub-areas SA0001, SA0002, SA0003, and the like shown in FIG. 2 have been registered. The “home line area” is information that can identify the line area to which the sub-area indicated by the concerned record belongs. In the example illustrated in FIG. 3, it is indicated that the sub-areas SA0001, SA0002 and SA0003 belong to the line areas LA0001, LA0001 and LA0002, respectively.

The “x coordinate” in the sub-area management table 142 is a value that indicates the position of the sub-area indicated by the record in the online WB 160. This “x coordinate” indicates the x coordinate (x coordinate value) of the left side (origin-side side) of the sub-area indicated by the record. As exemplified in FIG. 2, the x coordinates of the sub-areas SA0001, SA0002 and SA0003 are “0”, “x1” and “0” in that order.

The “area width” in the sub-area management table 142 is a value that indicates the width of the sub-area indicated by the record in the x-axis direction. As exemplified in FIG. 2, the area widths of the sub-areas SA0001, SA0002 and SA0003 are “x1”, “x2-x1” and “x3” in that order.

The “folding” in the sub-area management table 142 is information that indicates whether a sub-area indicated by the record is in the folded state in the online WB 160. In this exemplary embodiment, when the drawing control apparatus 10 has received drawing information from any one of the client apparatuses that instructs that a specific sub-area be in the folded state, the drawing control apparatus 10 reduces the specific sub-area in the x-axis negative direction and accordingly updates the online WB 160. In the example indicated in FIG. 3, the values indicated by the “folding” regarding the sub-areas SA0001, SA0002 and SA0003 are 0, indicating that these sub-areas are not in the folded state.

The “access right” in the sub-area management table 142 is information that indicates the ID (identification) of a user or users that are permitted to write into the sub-area indicated by the concerned record. The IDs of users are associated with the client apparatuses 20-1 to 20-n. For example, the ID of a user who uses the client apparatus 20-1 is U0001, and the ID of a user who uses the client apparatus 20-2 is U0002. In the example indicated in FIG. 3, the access right to the sub-area SA0001 has been given to the users whose user IDs are U0001 and U0002. In this case, with regard to the sub-area SA0001, the drawing control apparatus 10 updates the online WB 160 on the basis of only the drawing information received from the client apparatus 20-1 or 20-2. In other words, when the drawing control apparatus 10 has received drawing information regarding the sub-area SA0001 from any client apparatus other than the client apparatuses 20-1 and 20-2, the drawing control apparatus 10 rejects the update of the online WB 160 based on that drawing information. The sub-area management table 142 may include information that indicates the IDs of the users that are permitted to refer to the sub-areas indicated by the record.

The line area management table 141 and the sub-area management table 142 are updated by the change unit 12 when a change has occurred in the state of any line area or sub-area.

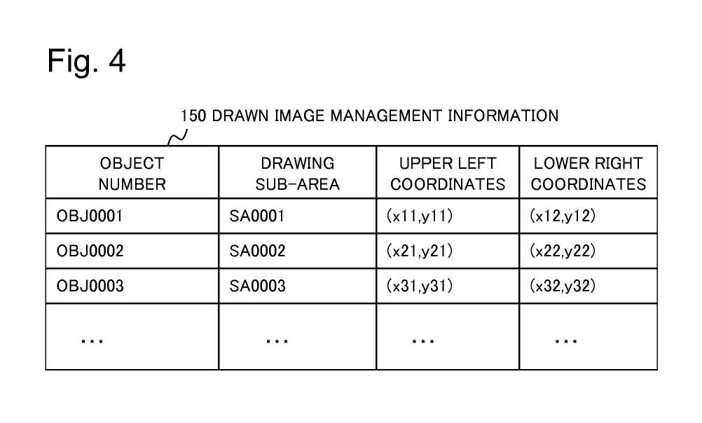

As illustrated in FIG. 1, the storage unit 15 stores drawn image management information 150. A construction example of the drawing image management information 150 according to this exemplary embodiment is indicated in FIG. 4.

The drawn image management information 150 is a table for managing the state of objects drawn in the online WB 160. The drawn image management information 150 has records in which items of “object number”, “drawing sub-area”, “upper left coordinates”, and “lower right coordinates” are associated with each other.

The “object number” indicates the object number given to each object. In the example indicated in FIG. 4, the objects OBJ0001, OBJ0002, OBJ0003, and the like indicated in FIG. 2 have been registered. The “drawing sub-area” is information that can identify a sub-area in which an object indicated by the concerned record has been drawn. In the example indicated in FIG. 4, it is indicated that the objects OBJ0001, OBJ0002 and OBJ0003 have been drawn in the sub-areas SA0001, SA0002 and SA0003 in that order.

The “upper left coordinates” and the “lower right coordinates” in the drawn image management information 150 are values that indicate the position in the online WB 160 regarding an object indicated by the concerned record. The “upper left coordinates” and the “lower right coordinates” indicate the xy coordinates of the upper left vertex (the vertex nearest to the origin) and the lower right vertex (the vertex farthest from the origin), respectively, of a rectangle that encloses the object indicated by the concerned record. Incidentally, the “upper left coordinates” and the “lower right coordinates” may also be coordinates within each drawn sub-area.

Each record in the drawn image management information 150 is registered by the move unit 13 when an object is newly drawn in the online WB 160, on the basis of the drawing information received from any one of the client apparatuses 20-1 to 20-n. Then, these records are updated by the move unit 13 when a change has occurred in the state of the object, on the basis of the drawing information received from any one of the client apparatuses 20-1 to 20-n.

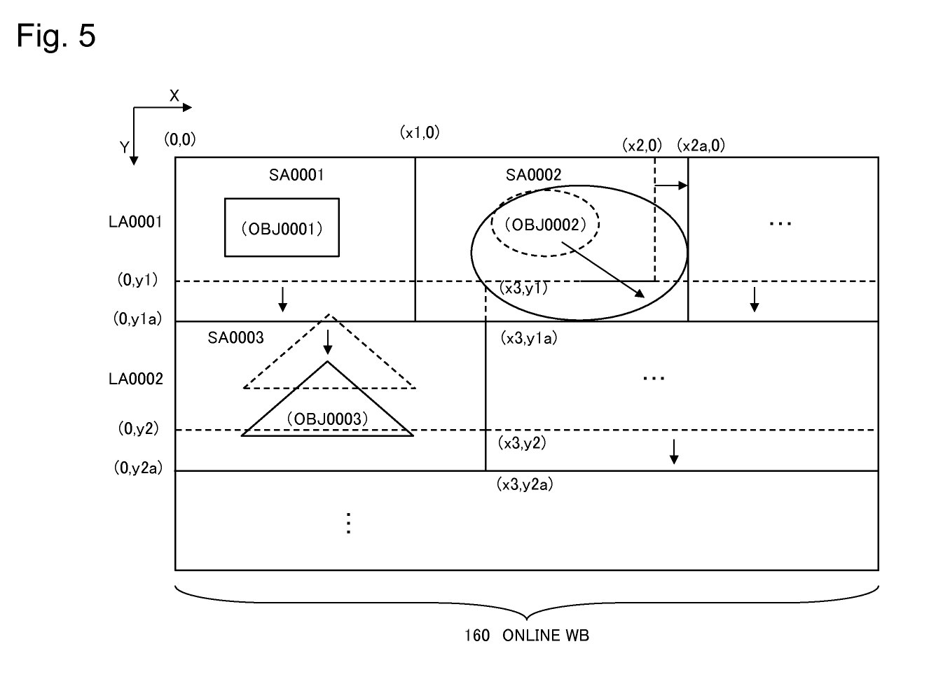

The determination unit 11 in this exemplary embodiment determines whether an object drawn in the online WB 160 is contained in the sub-area in which the object needs to be drawn. The determination unit 11 may perform this determination at predetermined time intervals or may also perform the determination at a time when the writing into the online WB 160 occurs. Now, a case where the content written in the online WB 160 has changed from the content exemplified in FIG. 2 to the content exemplified in FIG. 5 will be considered.

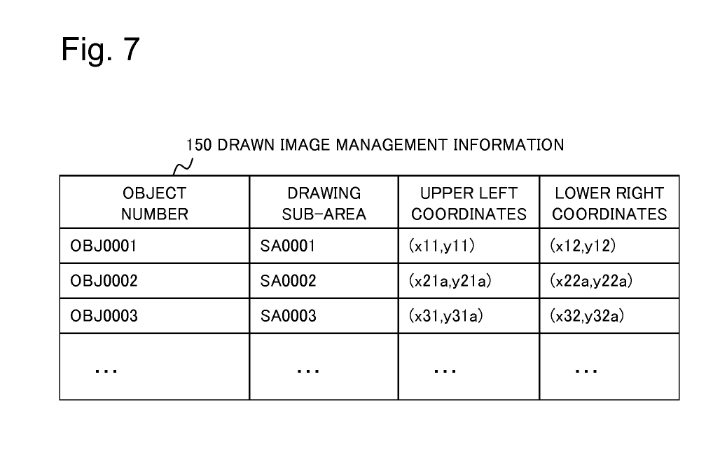

As exemplified in FIG. 5, the object OBJ0002 having been drawn in the sub-area SA0002 is expanded by a drawing instruction from the user U0002 (the client apparatus 20-2) that has the access right to the sub-area SA0002. At this time, the upper left coordinates and the lower right coordinates of the object OBJ0002 in the drawn image management information 150 are changed by the move unit 13 from values exemplified in FIG. 4 to values exemplified in FIG. 7. Specifically, with regard to the object OBJ0002, the upper left coordinates are changed from (x21, y21) to (x21a, y21a), and the lower right coordinates are changed from (x22, y22) to (x22a, y22a) (where x22<x22a and y22<y22a). On this occasion, the move unit 13 updates the records regarding the object OBJ0002 in the drawn image management information 150 from values exemplified in FIG. 4 to values exemplified in FIG. 7.

The determination unit 11, at this time, determines whether the expanded object OBJ0002 is contained in the sub-area SA0002 by referring to the drawing area management information 140 and the drawn image management information 150. More concretely, the determination unit 11 determines whether the foregoing coordinates (x22a, y22a) exist outside the sub-area SA0002 represented by the drawing area management information 140 exemplified in FIG. 3. The determination unit 11 inputs the result of this determination to the change unit 12.

When the determination unit 11 determines that an object drawn in the online WB 160 is not contained in the sub-area in which that object needs to be drawn, the change unit 12 changes at least either the size or the position regarding the sub-area so that the object will be contained in the sub-area. In the example illustrated in FIG. 5, the change unit 12 changes the size of the sub-area SA0002 so that the object OBJ0002 will be contained in the sub-area SA0002.

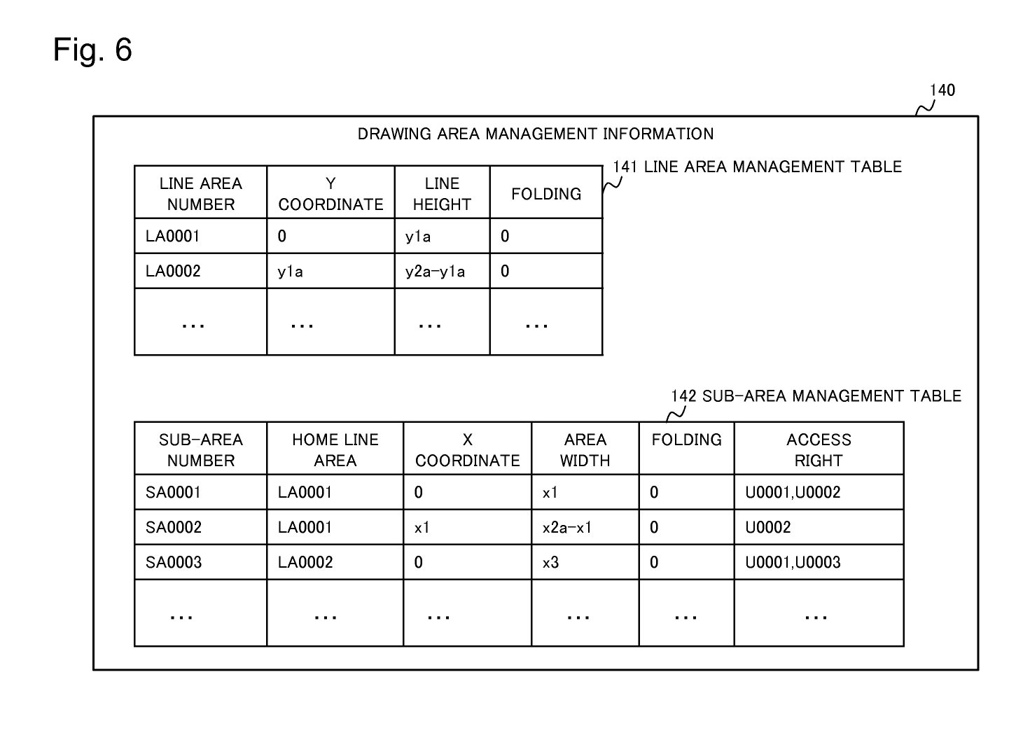

In this case, the change unit 12 first understands from the sub-area management table 142 that the sub-area SA0002 belongs to the line area LA0001. The change unit 12 changes the value of the line height of the line area LA0001 from “y1” to “y1a” (y1<y1a and y22a≦y1a) so that the object OBJ0002 is contained in the sub-area SA0002 in the y-axis direction. The change unit 12 changes the value of the y coordinate of the line area LA0002 from “y1” to “y1a” so that the line area LA0001 expanded in the y-axis positive direction will not overlap with the adjacent line area LA0002. Note that the change unit 12 does not change the value of the line height of the line area LA0002. In other words, the value “y2-y1” exemplified in FIG. 2 and the value “y2a-y1a” exemplified in FIG. 5 are equal. Furthermore, although not illustrated in FIG. 5, when the online WB 160 includes one or more line areas other than the line areas LA0001 and LA0002, the change unit 12 changes the value of the y coordinate of each of the one or more line areas so that no overlap occurs between the line areas. On that occasion, the change unit 12 may change the line heights of those line areas. By performing the foregoing process, the change unit 12 updates the line area management table 141 from the content exemplified in FIG. 3 to the content exemplified in FIG. 6.

Next, with respect to the x-axis direction, the change unit 12 changes the value of the area width of the sub-area SA0002 from “x2-x1” to “x2a-x1” (x2<x2a and x22a≦x2a) so that the object OBJ0002 will be contained in the sub-area SA0002. Although not illustrated in FIG. 5, when the line area LA0001 includes one or more sub-areas other than the sub-areas SA0001 and SA0002, the change unit 12 changes the values of the x coordinates of the one or more sub-areas so that no overlap occurs between the sub-areas. On that occasion, the change unit 12 may change the values of the area width of the sub-areas. By performing the foregoing process, the change unit 12 updates the sub-area management table 142 from the content exemplified in FIG. 3 to the content exemplified in FIG. 6.

The change unit 12 notifies the move unit 13 that the drawing area management information 140 has been updated.

The move unit 13 moves the object drawn in the sub-area whose position in the online WB 160 has been changed by the change unit 12, according to the post-move position regarding the sub-area.

In the example illustrated in FIG. 5, since the sub-area SA0003 has been moved in the y-axis positive direction in the online WB 160 by the change unit 12, the move unit 13 moves the object OBJ0003 drawn in the sub-area SA0003 in the y-axis positive direction. In this case, as exemplified in FIG. 4 and FIG. 7, the move unit 13 changes the y coordinate of the upper left coordinates regarding the object OBJ0003 from “y31” to “y31a” (y31<y31a). Likewise, the move unit 13 changes the y coordinate of the lower right coordinates of the object OBJ0003 from “y32” to “y32a” (y32<y32a). In this case, it is desirable to move the object OBJ0003 so that the relative positional relationship of the object OBJ0003 to the sub-area SA0003 is maintained.

Although not illustrated in FIG. 5, when any one or more sub-areas other than the sub-area SA0003 have been changed in the position in the online WB 160 by the change unit 12, the move unit 13 moves the object or objects drawn in the one or more sub-areas similarly to the object OBJ0003. The move unit 13, by performing the foregoing process, updates the drawn image management information 150 from the content exemplified in FIG. 4 to the content exemplified in FIG. 7.

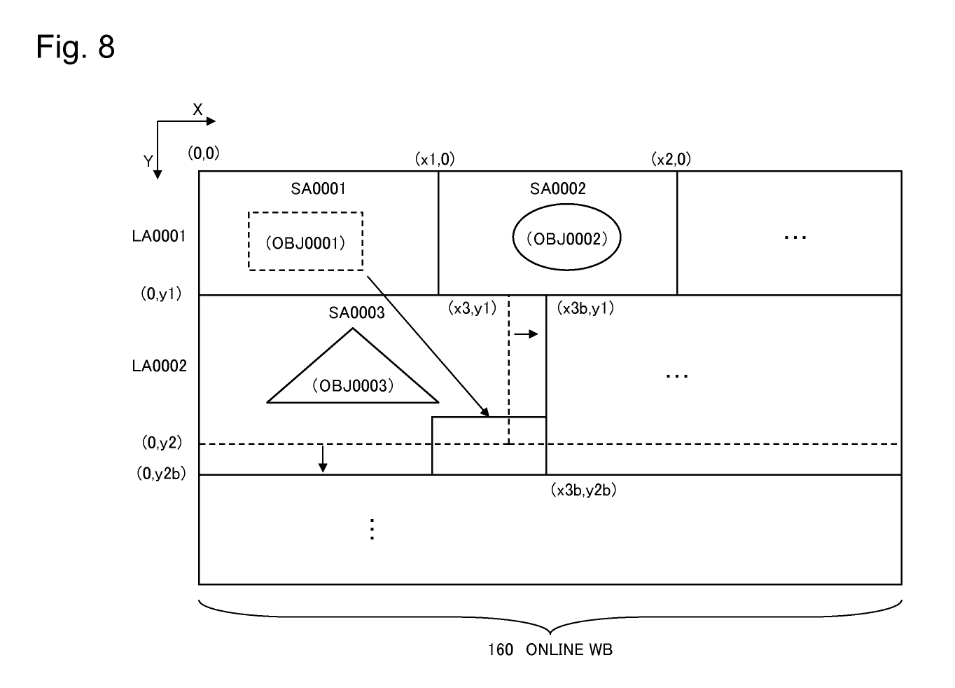

A second example regarding the update of the content written in the online WB 160 according to this exemplary embodiment is illustrated in FIG. 8. In the example illustrated in FIG. 8, the object OBJ0001 having been drawn in the sub-area SA0001 is moved to the sub-area SA0003 due to a drawing instruction from the user U0001 (the client apparatus 20-1) that has the access right to the sub-areas SA0001 and SA0003.

In this case, as exemplified in FIG. 8, the determination unit 11 determines that the object OBJ0001 moved from the sub-area SA0001 to the sub-area SA0003 is not contained in the sub-area SA0003.

The change unit 12 changes the value of the line height of the line area LA0002 from “y2-y1” to “y2b-y1” (y2-y1<y2b-y1) as exemplified in FIG. 8 so that the object OBJ0001 will be contained in the sub-area SA0003 in the y-axis direction. Although not illustrated in FIG. 8, when the online WB 160 includes one or more line area other than the line areas LA0001 and LA0002, the change unit 12 changes the values of the y coordinates of the one or more line areas so that no overlap occurs between the line areas.

Next, with respect to the x-axis direction, the change unit 12 changes the value of the area width of the sub-area SA0003 from “x3” to “x3b” (x3<x3b) so that the object OBJ0001 is contained in the sub-area SA0003. Although not illustrated in FIG. 8, when the line area LA0002 includes one or more sub-areas other than the sub-area SA0003, the change unit 12 changes the value of the x coordinate of the one or more sub-areas so that no overlap occurs between the sub-areas.

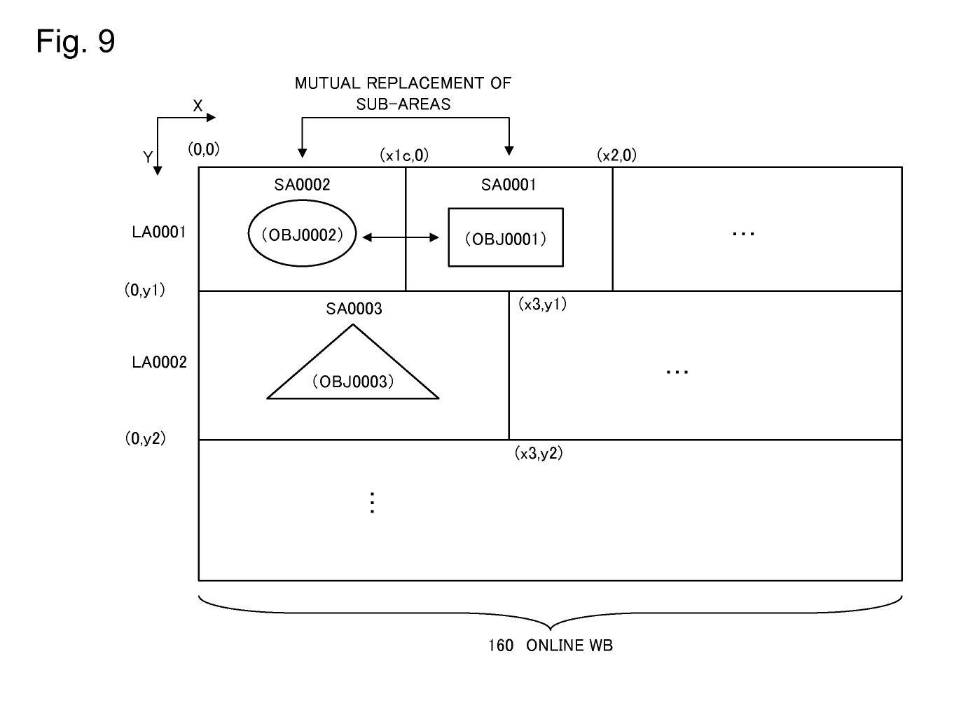

A third example regarding the update of the content written in the online WB 160 according to this exemplary embodiment is illustrated in FIG. 9. In the example illustrated in FIG. 9, the positions regarding the sub-areas SA0001 and SA0002 have been changed to each other due to a drawing instruction from the user U0001 (the client apparatus 20-1) that has the access right to the sub-areas SA0001 and SA0002.

In this case, the determination unit 11 determines that the object OBJ0001 is not contained in the sub-area SA0001 and the object OBJ0002 is not contained in the sub-area SA0002. The move unit 13 moves the objects OBJ0001 and OBJ0002 by changing the positions regarding the objects OBJ0001 and OBJ0002 to each other so that the objects OBJ0001 and OBJ0002 are contained in the sub-areas SA0001 and SA0002, respectively.

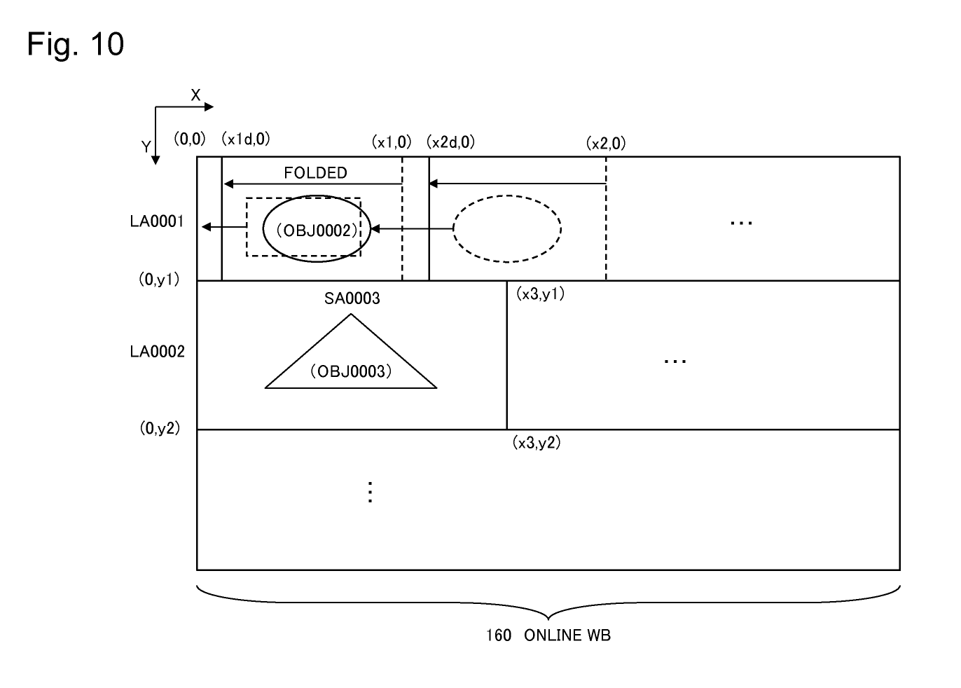

A fourth example regarding the update of the content written into the online WB 160 according to this exemplary embodiment is illustrated in FIG. 10. In the example illustrated in FIG. 10, the sub-area SA0001 is in the folded state in which the sub-area SA0001 has been reduced in the x-axis negative direction due to a drawing instruction from the user U0001 or U0002 that has the access right to the sub-area SA0001.

In this case, the change unit 12 moves the sub-area SA0002 in the x-axis negative direction by closing (deleting) the region in which the sub-area SA0001 was before being reduced to the folded state. In this case, with regard to the record regarding the sub-area SA0001 in the sub-area management table 142, the change unit 12 changes the value of the area width from “x1” to “x1d” (x1>x1d) and changes the value of the folding from “0” to “1”. Likewise, with regard to the record regarding the sub-area SA0002 in the sub-area management table 142, the change unit 12 changes the value of the x coordinate from “x1” to “x1d”.

The determination unit 11 determines that as a result of the movement of the sub-area SA0002, the object OBJ0002 is not contained in the sub-area SA0002. The move unit 13 moves the object OBJ0002 in the x-axis negative direction so that the object OBJ0002 is contained in the sub-area SA0002.

In the case where the sub-area SA0001 returns from the folded state in which the sub-area SA0001 has been reduced in the x-axis direction to the original state due to a drawing instruction from a user, the change unit 12 moves the sub-area SA0002 in the x-axis positive direction. In consequence, the determination unit 11 determines that the object OBJ0002 is not contained in the sub-area SA0002. Then, the move unit 13 moves the object OBJ0002 in the x-axis positive direction so that the object OBJ0002 is contained in the sub-area SA0002.

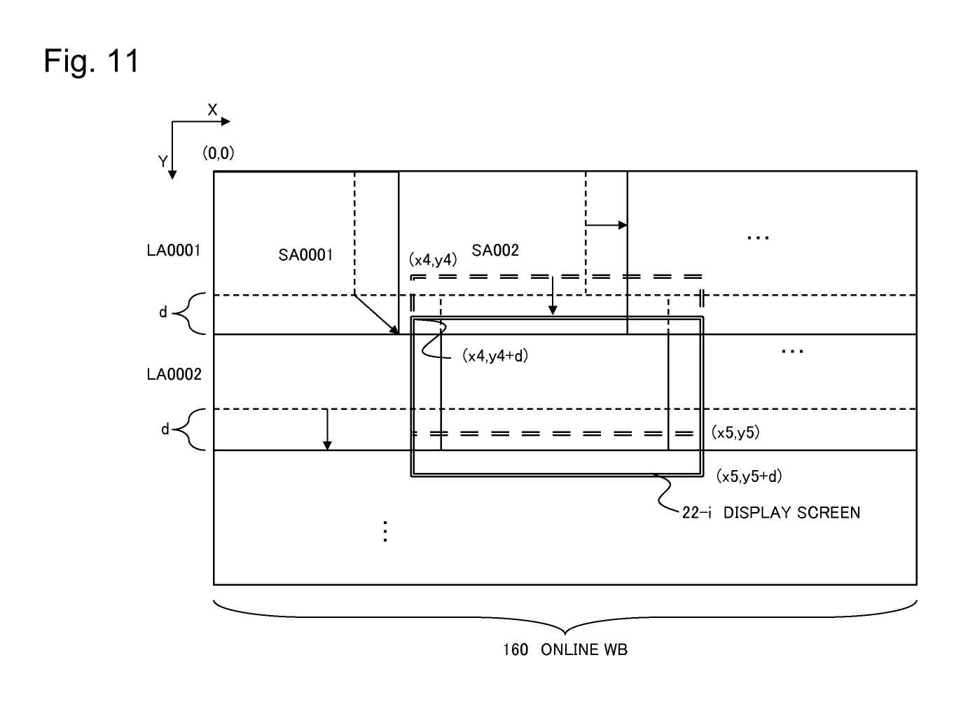

An example in which, along with the update of the content written in the online WB 160 according to this exemplary embodiment, the display unit 21-i of a client apparatus 20-i (i is an integer of 1 to n) adjusts the content displayed on a display screen 22-i is illustrated in FIG. 11.

In the example illustrated in FIG. 11, a user that accesses the online WB 160 from the client apparatus 20-i is editing the sub-area SA0004. The display screen 22-i is displaying an enlarged image of a working area that is a partial area of the online WB 160 and that contains the sub-area SA0004 and its surrounding region. It is assumed that, with regard to the rectangular working area in the online WB 160 displayed by the display screen 22-i, the coordinates of the upper left and lower right vertexes are (x4, y4) and (x5, y5), respectively. A case where, at this time, a user re-writes the content of the sub-area SA0001, so that the determination unit 11 and the change unit 12 cause the sub-area SA0001 to be expanded will be considered.

In this case, the value of the line height of the line area LA0001 is increased by “d”, the value of the y coordinate of the line area LA0002 increases by “d”. At this time, the display unit 21-i moves the working area displayed in the online WB 160 on the display screen 22-i by “d” in the y-axis positive direction. In other words, the coordinates of the upper left and lower right vertexes of the working area in the online WB 160 displayed by the display screen 22-i are (x4, y4+d) and (x5, y5+d), respectively. Due to this, even after the sub-area SA0001 is expanded, the display unit 21-i continues to display the working area having been displayed on the display screen 22-i before the expansion of the sub-area SA0001.

In the case where the display unit 21-i adjusts the content displayed on the display screen 22-i in conjunction with reduction of a sub-area, the following problem sometimes occurs. Since the distance from the working area to the x axis or y axis of the online WB 160 is less than the distance that the working area needs to be moved, the display unit 21-i cannot continue to display the working area on the display screen 22-i. In this case, the display unit 21-i inserts a pseudo-blank into the display screen 22-i so as to continue displaying this working area. The display unit 21-i deletes this pseudo-blank when the area displayed on the display screen 22-i is changed so that the pseudo-blank is not displayed on the display screen 22-i.

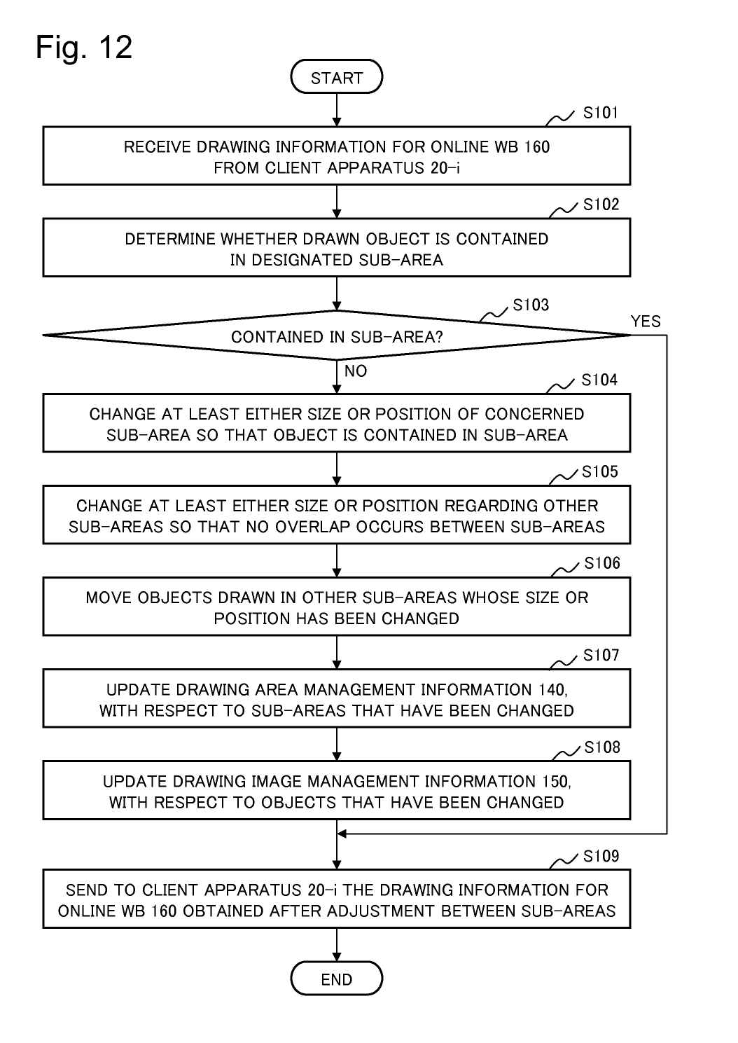

Next, with reference to a flowchart illustrated in FIG. 12, an operation (process) of the information sharing system 1 according to this exemplary embodiment will be described in detail.

The drawing control apparatus 10 receives drawing information for the online WB 160 from the client apparatus 20-i (step S101). The determination unit 11 determines whether the sub-area designated by the drawing information embraces the entire object drawn on the online WB 160 (step S102).

When the object drawn on the online WB 160 is contained in the designated sub-area (Yes in step S103), the whole process ends.

When the object drawn on the online WB 160 is not contained in the designated sub-area (No in step S103), the change unit 12 changes at least either the size or position regarding the sub-area so that the object is contained in the sub-area (step S104). The change unit 12 changes at least either the size or position regarding other sub-areas so that no overlap occurs between areas in the online WB 160 (step S105).

The move unit 13 moves the objects drawn in other sub-areas that have changed in size or position (step S106). The change unit 12 updates the drawing area management information 140 with regard to any sub-area that has changed in size or position (step S107). The move unit 13 updates the drawn image management information 150 with regard to any object that has been changed (step S108).

The drawing control apparatus 10 sends to the client apparatus 20-i drawing information for the online WB 160 obtained after adjustment between sub-areas has been performed (step S109). Then, the whole process ends.

The information sharing system 1 according to this exemplary embodiment is capable of efficiently performing an adjustment process of making adjustment such that the writing areas for a plurality of users do not overlap with each other in an information sharing system in which information that users have written in after gaining access on-line. A reason for that is that, in the case where the determination unit 11 has determined that the object drawn on the online WB 160 is not contained in the designated area, the change unit 12 changes at least either the position or size regarding areas that include the designated area so that the object is contained in the designated area and so that no area overlaps with another. Furthermore, the move unit 13 moves the object drawn in an area having been changed in at least either position or size, according to the post-change position and size regarding the area.

When an information sharing apparatus, such as an online WB that is capable of displaying information written by a plurality of users that has gained access on-line, is used, the users write information into the users' own drawing areas in the online WB during an early period. However, if, as a user's thinking and idea expands, blank portions become scarce in the user's drawing area, the user may sometimes write information beyond the user's drawing area. In such a case, pieces of information written by a plurality of users coexist in the same area on the online WB, and it becomes difficult to tidy the pieces of information. According to the related art, when a user sees that the user's drawing area is going to overlap with another user's drawing area, the user manually performs an adjustment process of moving the user's written information to a blank space in the online WB, giving rise to a problem of time and labor consumption.

However, the information sharing system 1 according to this exemplary embodiment manages the drawing area of each user and the drawn image (object) drawn in each drawing area by using the drawing area management information 140 and the drawn image management information 150. Then, in a case as mentioned above, the determination unit 11 determines that there is a drawn image not contained in its specific drawing area on the basis of the drawing area management information 140 and the drawn image management information 150. Then, the change unit 12 changes at least either the size or position regarding that specific drawing area so that the drawn image is contained in the specific drawing area. The change unit 11 also changes at least either the size or position regarding other drawing areas so that the aforementioned specific drawing area does not overlap with another drawing area. Next, the move unit 13 moves the drawn images drawn in the other drawing areas, according to the post-change sizes and positions regarding the drawing areas. Thus, the information sharing system 1 according to this exemplary embodiment is able to automatically perform the adjustment process that users need to manually perform in the related art, so that the burden on the users can be reduced.

Furthermore, the information sharing system 1 according to this exemplary embodiment changes the position in the online WB 160 regarding each drawing area while maintaining the relative positional relationship of the drawing areas. Therefore, the information sharing system 1 is able to avoid an event that, as a result of the adjustment process of avoiding overlap between drawing areas of users, the entire image drawn in the online WB 160 is disturbed so that it is difficult to tidy the pieces of information displayed in the online WB 160.

Furthermore, the information sharing system 1 according to this exemplary embodiment changes the size or position regarding a drawing area on the basis of an instruction from the user. Therefore, the users of the information sharing system 1 can flexibly use the online WB 160.

Furthermore, in the drawn image management information 150 according to this exemplary embodiment, the coordinates regarding an object can sometimes be coordinates with reference to the corresponding sub-area. In such a case, the move unit 13 does not need to update the drawn image management information 150 with regard to the object drawn in the sub-area whose position in the online WB 160 has been changed. Furthermore, if, in such a case, mutual replacement of sub-areas occurs, the determination unit 11 does not need to perform the determination process.

Furthermore, the information sharing system 1 according to this exemplary embodiment performs the adjustment process of avoiding overlap between the drawing areas of users in the unit of groups by, for example, grouping areas whose y coordinates are equal as a single line area and changing the line height, and the like. Due to this, the information sharing system 1 can efficiently perform the adjustment process.

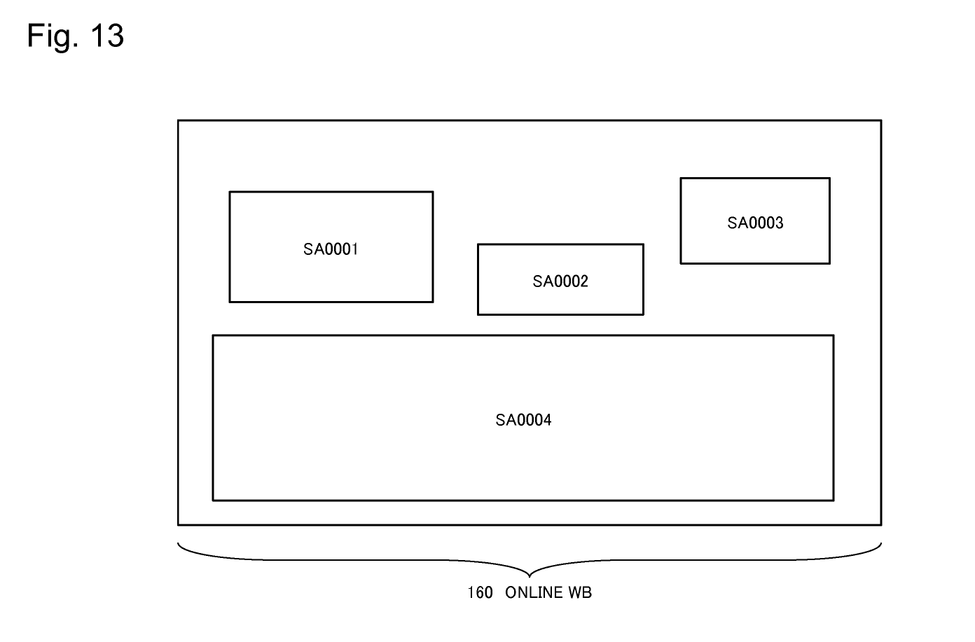

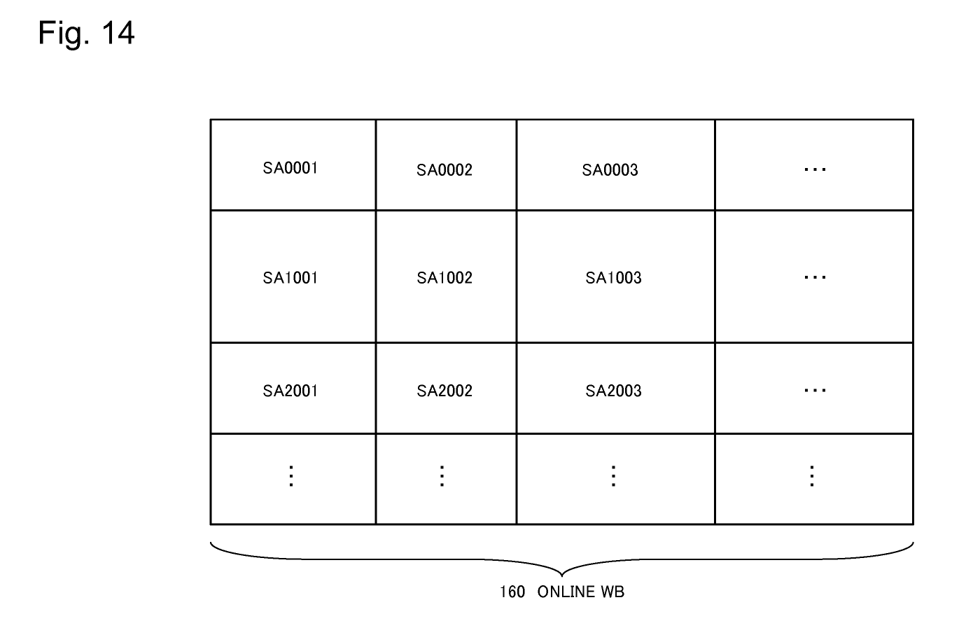

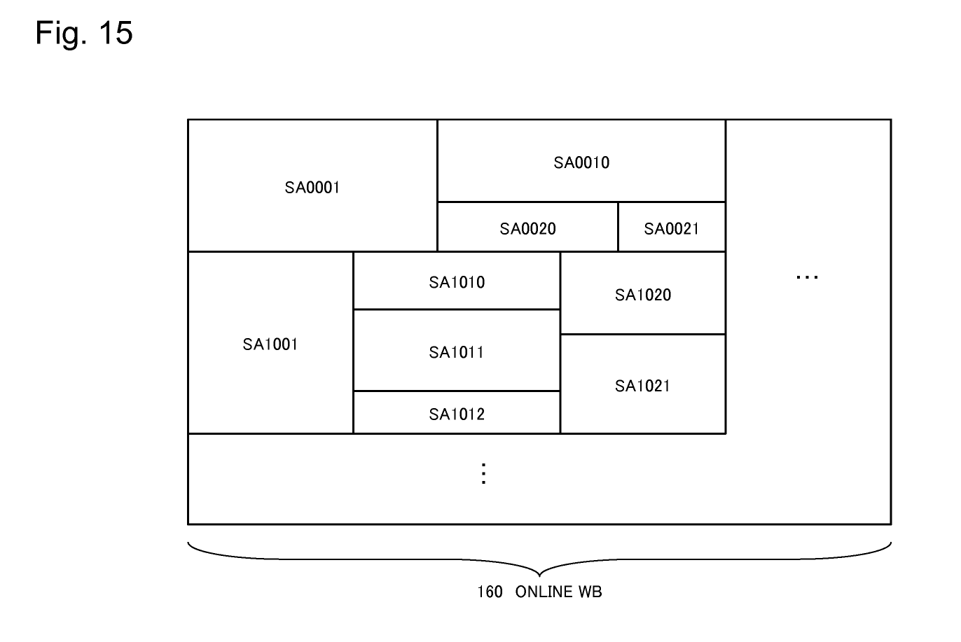

Note that the method of setting areas is not limited to a method that uses line areas as exemplified in FIG. 2. For example, as exemplified in FIG. 13, areas may be, instead of being adjacent to each other, arranged at positions apart from each other, like floating islands. In this method, the users are allowed to place the areas of the users, like objects, at positions that the users like by dragging and dropping the areas or inputting a predetermined command, so that the users can flexibly use the online WB 160. Furthermore, in a method for setting areas, areas may be arranged in the form of a grid, as exemplified in FIG. 14. In this method, the adjustment process of avoiding overlap between the drawing areas of users can be more efficiently performed by defining row areas in addition to line areas. Furthermore, as for the method of setting areas, the grouping of areas may be even more flexibly carried out as exemplified in FIG. 15.

Furthermore, in the information sharing system 1 according to this exemplary embodiment, after the adjustment process of avoiding overlap between the drawing areas of users occurs, each of the display units 21-1 to 21-n of the client apparatuses continues to display the working area displayed on the display screen before the execution of the adjustment process. Due to this, each user is free from the influence of the adjustment process that occurs on the occasion of another user writing into the online WB 160 and can continue to perform the user's own operation without shifting the user's eyes.

Although the drawing control apparatus 10 according to this exemplary embodiment includes the storage unit 14, the storage unit 15, and the memory 16, the drawing control apparatus 10 does not need to include these components. For example, a construction in which the storage unit 14, the storage unit 15, and the memory 16 exist as separate apparatuses and the drawing control apparatus 10 is connected to these apparatuses so that communication is possible therebetween.

Furthermore, each of the client terminal apparatuses 20-1 to 20-n in this exemplary embodiment may be an apparatus such as an electronic blackboard equipped with a large-screen liquid crystal display type touch panel.

### Second Exemplary Embodiment

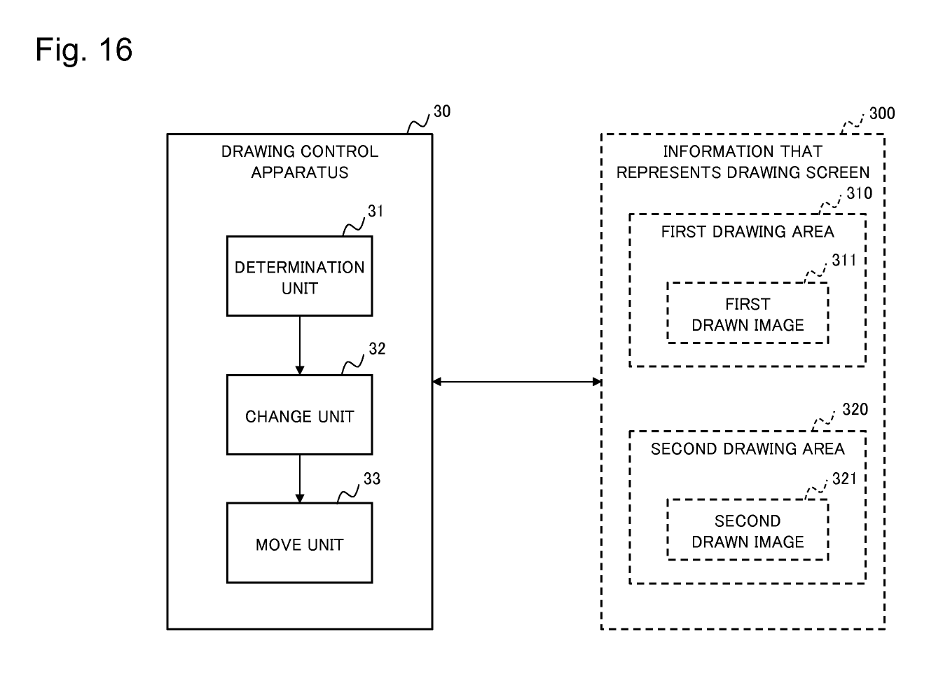

FIG. 16 is a block diagram conceptually illustrating a construction of a drawing control apparatus 30 according to a second exemplary embodiment of the present invention.

The drawing control apparatus 30 according to this exemplary embodiment is an apparatus that controls the drawing performed on information 300 that represents a drawing screen capable of displaying information that a plurality of users having gained access on-line writes. The drawing control apparatus 30 includes a determination unit 31, a change unit 32, and a move unit 33.

The determination unit 31 determines whether, in the information 300 that represents the drawing screen that includes a plurality of drawing areas, a first drawn image 311 drawn on the basis of an instruction that the first drawn image be drawn within a first drawing area 310 of the plurality of drawing areas is contained in the first drawing area 310.

When the first drawn image 311 is not contained in the first drawing area 310, the change unit 32 changes at least either information that represents the size regarding the first drawing area 310 or information that represents the position in the drawing screen regarding the first drawing area 310 in such a changing manner that the first drawn image 311 is contained in the first drawing area 310. Then, with regard to the second drawing area 320 of the plurality of drawing areas, the change unit 32 changes at least either information that represents the size regarding the second drawing area 320 or information that represents the position in the drawing screen regarding the second drawing area 320 in such a changing manner that the second drawing area 320 does not overlap with the first drawing area 310.

The move unit 33 moves the second drawn image 321 drawn on the basis of an instruction that the second drawn image 321 be drawn within the second drawing area 320, according to the post-change size and position regarding the second drawing area 320.

The drawing control apparatus 30 according to this exemplary embodiment, in an information sharing system capable of displaying information that a plurality of users having gained access on-line writes, can efficiently perform the adjustment process of avoiding overlap between the writing areas for the users. A reason for that is that, in the case where the determination unit 31 has determined that the drawn image drawn in the information 300 that represents the drawing screen is not contained in the designated drawing area, the change unit 32 changes at least either the position or size regarding drawing areas that include the designated drawing area so that the drawn image is contained in the designated drawing area and so that no drawing area overlaps with another. Furthermore, the move unit 33 moves the drawn images drawn in the drawing areas having been changed in at least either position or size, according to the post-change position and size regarding the drawing areas.

### Example of Hardware Configuration

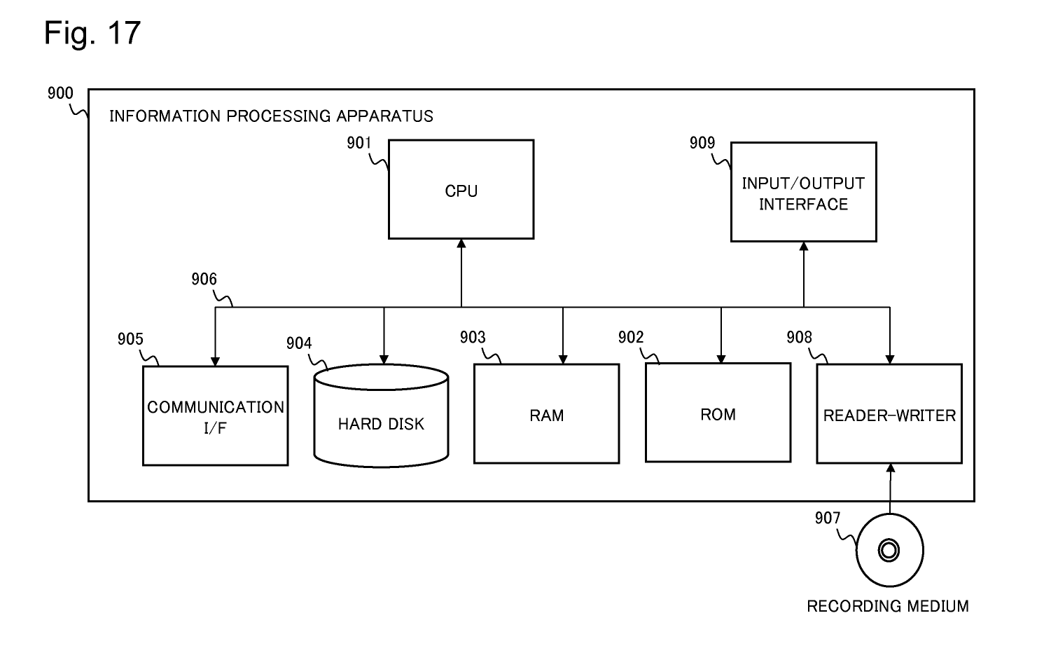

In the foregoing exemplary embodiments, the various units illustrated in FIG. 1 and FIG. 16 can be realized by dedicated hardware elements (electronic circuits). Furthermore, at least the determination units 11 and 31, the change units 12 and 32, and the move units 13 and 33 can be considered as function (process) units of a software program (software modules). However, the unitization of the various units illustrated in FIGS. 1 and 16 are of constructions for the sake of description and, for real packaging, various other constructions are also conceivable. An example of a hardware environment in that case will be described with reference to FIG. 17.

FIG. 17 is a diagram exemplarily illustrating a construction of an information processing apparatus 900 (computer) that can implement a drawing control apparatus according to an exemplary embodiment of the present invention. FIG. 17 represents a hardware environment which is a construction of a computer (information processing apparatus) that can implement the drawing control apparatuses illustrated in FIG. 1 and FIG. 16 and which can realize the various functions of the foregoing exemplary embodiments.

An information processing apparatus 900 illustrated in FIG. 17 includes the following components:

a CPU (Central Processing Unit) 901

a ROM (Read Only Memory) 902

a RAM (Random Access Memory) 903

a hard disk drive 904 (storage apparatus)

a communication interface 905 for an external apparatus

a reader-writer 908 capable of reading and writing data from and into a recording medium 907 such as a CD-ROM (Compact Disc Read-Only Memory)

an input/output interface 909

The information processing apparatus 900 is a common computer in which these components are connected via a bus 906 (communication line).

In the invention described above with reference to the exemplary embodiments, a computer program capable of realizing the following functions is supplied to the information processing apparatus 900 illustrated in FIG. 17. The functions are functions performed by the determination units 11 and 31, the change units 12 and 32, and the move units 13 and 33 in the block construction diagrams (FIG. 1 and FIG. 16) that are referred to in the foregoing description of the exemplary embodiments or according to the flowchart (FIG. 12). The invention is accomplished as the CPU 901 of the foregoing hardware construction reads out, interprets and executes the computer program. Furthermore, it suffices that the computer program supplied into this apparatus is stored in a readable and writable volatile storage memory (RAM 903) or a non-volatile storage device such as the hard disk drive 904.

Furthermore, as for the method for supplying the computer program into the foregoing hardware construction, a presently common procedure can be adopted. Examples of the procedure include a method in which the computer program is installed in the apparatus via various types of recording medium 907, such as a CD-ROM, a method in which the computer program is downloaded from outside via a communication line such as the Internet, and the like. In such a case, the invention can be considered as being constructed by codes that constitute the foregoing computer program or the recording medium 907 that store the codes.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even when the claims are amended during prosecution.

1. A drawing control apparatus comprising:
a determination unit configured to determine whether, in information that represents a drawing screen that includes a plurality of drawing areas, a first drawn image drawn based on an instruction that the first drawn image be drawn in a first drawing area of the plurality of drawing areas is contained in the first drawing area;
a change unit configured to, when, in the information that represents the drawing screen, the first drawn image is not contained in the first drawing area, change at least either information that represents a size regarding the first drawing area or information that represents a position in the drawing screen regarding the first drawing area so that the first drawn image is contained in the first drawing area, and to change at least either information that represents a size regarding a second drawing area of the plurality of drawing areas or information that represents a position in the drawing screen regarding the second drawing area so that the second drawing area does not overlap with the first drawing area; and
a move unit configured to move a second drawn image drawn based on an instruction that the second drawn image be drawn in the second drawing area, according to the size and the position regarding the second drawing area that are obtained after change regarding the second drawing area.

2. The drawing control apparatus according to claim 1, wherein, regarding the first drawing area and the second drawing area, the change unit changes the information that represents the position in the drawing screen so that a relative positional relationship between the first drawing area and the second drawing area is maintained.

3. The drawing control apparatus according to claim 1,
wherein the change unit changes at least either the information that represents the size or the information that represents the position in the drawing screen regarding the first drawing area, according to an instruction received from outside, and
wherein the move unit moves the first drawn image according to the size and the position regarding the first drawing area that are obtained after the change regarding the first drawing area.

4. The drawing control apparatus according to claim 1,
wherein the determination unit refers to
drawing area management information that includes a first record in which an identifier that is capable of identifying a specific drawing area and values that indicate the size regarding the specific drawing area and the position in the drawing screen regarding the specific drawing area are associated, and
drawn image management information that includes a second record in which an identifier that is capable of identifying a specific drawn image, values that indicate the size regarding the specific drawn image and the position in the drawing screen regarding the specific drawn image, and an identifier that is capable of identifying the specific drawing area in which to draw the specific drawn image are associated,
and then
determines whether the first drawn image is contained in the first drawing area by collating a content of the first record regarding the first drawing area and a content of the second record regarding the first drawn image, and
wherein the change unit changes the first record according to a content obtained by changing at least either the information that represents the size or the information that represents the position in the drawing screen regarding the first drawing area or the second drawing area, and
wherein the move unit changes the second record according to the position regarding the second drawn image which is obtained after move regarding the second drawn image.

5. The drawing control apparatus according to claim 4, wherein the drawing area management information is information in which the specific drawing areas whose coordinates in a specific direction in the drawing screen are equal are grouped.

6. The drawing control apparatus according to claim 5,
wherein the drawing area management information is information in which an identifier that is capable of identifying a client apparatus that instructs that the specific drawn image be drawn in the specific drawing area and an identifier that is capable of identifying the specific drawing area are associated, and
wherein, when the move unit is instructed by the client apparatus that the specific drawn image be drawn in the specific drawing area, the move unit gives the specific drawn image an identifier that is capable of identifying the drawn image, and registers in the drawn image management information the second record in which the identifier given to the specific drawn image, the values that indicate the size regarding the specific drawn image and the position in the drawing screen regarding the specific drawn image, and the identifier that is capable of identifying the specific drawing area are associated.

7. The drawing control apparatus according to claim 4, wherein, when the drawn image management information includes coordinates given with reference to the specific drawing area as a value in the second record which indicates the position in the drawing screen regarding the specific drawn image, the move unit omits a process of changing the second record according to the position obtained after the move regarding the second drawn image.

8. An information sharing system comprising:
the drawing control apparatus according to claim 6;
a first storage apparatus configured to be capable of storing the information that represents the drawing screen;
a second storage apparatus configured to be capable of storing the drawing area management information;
a third storage apparatus configured to be capable of storing the drawn image management information; and
the client apparatus that includes a display unit capable of displaying a specific area, which is to be a working area, included in the drawing screen on a display screen,
wherein the display unit displays the working area on the display screen in a state in which a position of the working area that is displayed on the display screen is maintained when the change unit has changed at least either the information that represents the size or the information that represents the position in the drawing screen regarding the first drawing area or the second drawing area and also when the display unit is displaying the working area, on the display screen, that includes at least a portion of the second drawing area.

9. A drawing control method comprising:
by an information processing apparatus,
determining whether, in information that represents a drawing screen that includes a plurality of drawing areas, a first drawn image drawn based on an instruction that the first drawn image be drawn in a first drawing area of the plurality of drawing areas is contained in the first drawing area;
when, in the information that represents the drawing screen, the first drawn image is not contained in the first drawing area, changing at least either information that represents a size regarding the first drawing area or information that represents a position in the drawing screen regarding the first drawing area so that the first drawn image is contained in the first drawing area, and changing at least either information that represents a size regarding a second drawing area of the plurality of drawing areas or information that represents a position in the drawing screen regarding the second drawing area so that the second drawing area does not overlap with the first drawing area; and
moving a second drawn image drawn based on an instruction that the second drawn image be drawn in the second drawing area, according to the size and the position regarding the second drawing area that are obtained after change regarding the second drawing area.

10. A non-transitory computer-readable medium storing a drawing control program casing a computer to realize:
a determination function configured to determine whether, in information that represents a drawing screen that includes a plurality of drawing areas, a first drawn image drawn based on an instruction that the first drawn image be drawn in a first drawing area of the plurality of drawing areas is contained in the first drawing area;
a change function configured to, when, in the information that represents the drawing screen, the first drawn image is not contained in the first drawing area, change at least either information that represents a size regarding the first drawing area or information that represents a position in the drawing screen regarding the first drawing area so that the first drawn image is contained in the first drawing area, and to change at least either information that represents a size regarding a second drawing area of the plurality of drawing areas or information that represents a position in the drawing screen regarding the second drawing area so that the second drawing area does not overlap with the first drawing area; and
a move function configured to move a second drawn image drawn based on an instruction that the second drawn image be drawn in the second drawing area, according to the size and the position regarding the second drawing area that are obtained after change regarding the second drawing area.
